(19) United States
(12) Patent Application Publication
(10) Pub. No.: US 2003/0007890 A1
(43) Pub. Date: Jan. 9, 2003

(54) Detection-membrane and optical sensor using the same

(76) Inventors: Kazuhiro Mitani, Chichibu-shi (JP); Teruyuki Kobayashi, Chichibu-shi (JP); Takayuki Kamemura, Chichibu-shi (JP); Nobuo Uotani, Chiba-shi (JP); Yuji Itoh, Chiba-shi (JP)

Correspondence Address: SUGHRUE, MION, ZINN, MACPEAK & SEAS PLLC, 2100 PENNSYLVANIA AVENUE, N.W., WASHINGTON, DC, 20037-3213, US

(21) Appl. No.: 09/825,356

(22) Filed: Apr. 4, 2001

Related U.S. Application Data
(60) Provisional application No. 60/264,679, filed on Jan. 30, 2001.
(60) Provisional application No. 60/264,680, filed on Jan. 30, 2001.

(30) Foreign Application Priority Data
Apr. 4, 2000 (JP) 2000-101655
May 9, 2000 (JP) 2000-135590

(51) Int. Cl. G01N 31/22

(52) U.S. Cl. 422/56; 422/82.05; 436/170; 436/172

(57) ABSTRACT

By forming a detection-membrane with a light reflective layer in which the detection-membrane is a multilayer construction with a protective layer, a detection-membrane can be provided which is able to be used favorably within an optical sensor, will suffer no reduction in mechanical strength as a result of external factors such as physical pressure, high temperature, high humidity or the like, and will cause no deterioration in the characteristics of an optical sensor, and an optical sensor which utilizes such a detection-membrane can also be provided.

### CROSS-REFERENCES TO RELATED APPLICATIONS

This application claims the benefit of applications based on U.S. Provisional Patent Application Ser. No. 60/264,679 (filed on Jan. 30, 2001) and U.S. Provisional Patent Application Ser. No. 60/264,680 (filed on Jan. 30, 2001).

### BACKGROUND OF THE INVENTION

1. Field of the Invention

The present invention relates to a detection-membrane and an optical sensor using the detection-membrane. This specification is based on patent applications made in Japan (Japanese Patent Application, No. 2000-101655, and Japanese Patent Application, No. 2000-135590), the entire disclosures of which are incorporated herein by reference.

2. Background Art

Conventionally, physical quantities such as acceleration, pressure and sound waves have been measured using a variety of methods, including measuring a material displacement caused by a force by detecting a displacement in electrostatic capacity or measuring an electrical resistance or a magnetic resistance. Furthermore, a variety of optical sensors, which detect the above displacement by converting the displacement into a low optical intensity, have also been proposed. These optical sensors are used in microphones and various portable equipment.

Because optical sensors are unaffected by magnetic fields and the like, they react more rapidly to changes in physical factors than the other methods described above which utilize electromagnetism, are resistant to noise, and display good sensitivity, and offer significant industrial advantages.

In order to improve the sensitivity of optical sensors, it is necessary to make the detection-membrane causing the displacement as thin as possible. However, as the detection-membrane is made thinner, the membrane strength drops, and problems such as membrane rupture and membrane warping are more likely to occur, making the detection-membrane more susceptible to damage. The reliability of the optical sensor then suffers as a result.

Furthermore, optical sensors are often used under adverse environmental conditions such as high temperature or high humidity, leading to possible corrosion of the detection-membrane. As a result, the detection-membrane is even more likely to suffer damage, and additional problems arise in that a reduction in optical reflectivity as a result of such corrosion, will produce reductions in the sensitivity and the S/N ratio of the optical sensor.

Furthermore, recent developments in portable equipment have created a demand for even smaller optical sensors and microphones and the like.

### SUMMARY OF THE INVENTION

An object of the present invention is to provide a detection-membrane which can be used favorably within an optical sensor, will suffer no reduction in mechanical strength as a result of external factors such as physical pressure, temperature, humidity or the like, and will cause no deterioration in the characteristics of the optical sensor, as well as an optical sensor which utilizes such a detection-membrane.

In other words, an object of the present invention is to provide a detection-membrane in which either the mechanical strength or the environmental resistance characteristics, or preferably both such characteristics, have been improved, as well as an optical sensor which utilizes such a detection-membrane.

As a result, another object is to provide an optical sensor which displays good strength, high sensitivity, a superior S/N ratio, and good environmental resistance characteristics, and which is preferably small in size.

In order to achieve the above objects, a first aspect of the present invention is a detection-membrane with a light reflective layer, wherein the detection-membrane has a multilayer construction with a protective layer.

A second aspect of the present invention is a detection-membrane according to the first aspect, wherein the outermost layer on one side or both sides of the detection-membrane is the aforementioned protective layer.

A third aspect of the present invention is a detection-membrane according to the first aspect, wherein an aforementioned protective layer is provided above and below the light reflective layer.

A fourth aspect of the present invention is a detection-membrane according to the first aspect, wherein the aforementioned light reflective layer is either a metallic layer or a synthetic resin layer with metallic particles dispersed therein.

A fifth aspect of the present invention is a detection-membrane according to the fourth aspect, wherein the aforementioned metallic layer or metallic particles are formed from a metal selected from the group consisting of Al, Ni, Cu, Fe, Mg, Au, Ti, Cr, Co, Ba, Si, Ag and Pt, or alternatively are formed from an alloy comprising at least one metal selected from the same group.

A sixth aspect of the present invention is a detection-membrane according to the first aspect, wherein the aforementioned light reflective layer is formed from a metal oxide compound.

A seventh aspect of the present invention is a detection-membrane according to the sixth aspect, wherein the aforementioned metal oxide compound is either one, or two or more, of the compounds selected from the group consisting of Al₂O₃, Ba₂O₃, Mg₂O₃ and SiO₂.

An eighth aspect of the present invention is a detection-membrane according to the first aspect, wherein the aforementioned protective layer is formed from a synthetic resin.

A ninth aspect of the present invention is a detection-membrane according to the eighth aspect, wherein the protective layer is formed from either one, or two or more, of the resins selected from the group consisting of vinyl based setting resins, epoxy based setting resins, urethane based setting resins, silicone based setting resins and silicon dioxide based setting resins.

A tenth aspect of the present invention is a detection-membrane according to the eighth aspect, wherein the protective layer is formed from either one, or two or more, of the resins selected from the group consisting of polyimides, fluororesins, polyethylene terephthalate and polystyrene.

An eleventh aspect of the present invention is a detection-membrane according to the first aspect, wherein the aforementioned protective layer is formed from a metal selected from the group consisting of Au, Cr, Ni, Zr and Pt, or alternatively is formed from an alloy comprising at least one metal selected from the same group.

A twelfth aspect of the present invention is a detection-membrane according to the first aspect, wherein the aforementioned protective layer is formed from either one of, or both of, the compounds SiO₂ and Si₃N₄.

A thirteenth aspect of the present invention is a detection-membrane according to the first aspect, wherein the thickness of the detection-membrane is between 0.01 and 20 μm.

A fourteenth aspect of the present invention is a detection-membrane according to the first aspect, wherein the specific gravity of the detection-membrane is between 14.5 and 0.5.

A fifteenth aspect of the present invention is a detection-membrane with a support, wherein a support for supporting the periphery of a detection-membrane according to the first aspect is provided on at least one side of the detection-membrane.

A sixteenth aspect of the present invention is a detection-membrane with a support according to the fifteenth aspect, wherein the surface area of the section of the detection-membrane not supported by the support is between 2×10⁻⁴ and 0.3 cm².

A seventeenth aspect of the present invention is a detection-membrane with a support according to the fifteenth aspect, wherein a protective layer of a synthetic resin is provided on the surface of the detection-membrane facing the support, and the protective layer also functions as an adhesive layer for the support.

An eighteenth aspect of the present invention is a detection-membrane with a support according to the fifteenth aspect, wherein the support is formed from one, or two or more materials selected from the group consisting of Al, Ni, Cu, Fe, Mg, GaAs, Si, GaP, InP, GaAlAs and Al₂O₃.

A nineteenth aspect of the present invention is a detection-membrane with a support according to the fifteenth aspect, wherein the support is formed from one, or two or more materials selected from the group consisting of vinyl based setting resins, epoxy based setting resins, urethane based setting resins and silicone based setting resins.

A twentieth aspect of the present invention is a detection-membrane with a support according to the fifteenth aspect, wherein the support has a movable section at the joint with the detection-membrane which can move in accordance with vibration of the detection-membrane.

A twenty first aspect of the present invention is a detection-membrane with a support according to the twentieth aspect, wherein the support has a protruding section protruding into the center of the detection-membrane with a length in the direction of the detection-membrane thickness which gradually decreases towards the center, and the protruding section functions as the aforementioned movable section.

A twenty second aspect of the present invention is a detection-membrane with a support according to the twentieth aspect, wherein the aforementioned movable section is formed from an elastic material.

A twenty third aspect of the present invention is a detection-membrane with a support according to the twenty second aspect, wherein the movable section is formed from a single crystal material.

A twenty fourth aspect of the present invention is a detection-membrane with a support according to the twenty third aspect, wherein the single crystal material is any one of the materials selected from the group consisting of Si, GaAs, GaAlAs, GaP, InP and Al₂O₃.

A twenty fifth aspect of the present invention is a detection-membrane with a support according to the twenty second aspect, wherein the aforementioned movable section is formed from a metal.

A twenty sixth aspect of the present invention is a detection-membrane with a support according to the twenty fifth aspect, wherein the aforementioned metal is selected from the group consisting of Al, Ni, Cu, Fe and Mg, or alternatively is formed from an alloy comprising at least one metal selected from the same group.

A twenty seventh aspect of the present invention is a detection-membrane with a support according to the twenty second aspect, wherein the aforementioned movable section is formed from a synthetic resin.

A twenty eighth aspect of the present invention is a detection-membrane with a support according to the twenty seventh aspect, wherein the synthetic resin is formed from either one, or two or more, of the materials selected from the group consisting of polyimides, fluororesins, epoxy resins, synthetic rubbers, polystyrene, bakelite, polyethylene and polypropylene.

A twenty ninth aspect of the present invention is an optical sensor comprising a detection-membrane with a support according to the fifteenth aspect, a light emitting element for irradiating light onto the detection-membrane supported by the support, and a light receiving element for receiving reflected light reflected off the detection-membrane.

A thirtieth aspect of the present invention is an optical sensor according to the twenty ninth aspect, wherein the light emitting element and the light receiving element are positioned on the same side of the detection-membrane.

A thirty first aspect of the present invention is a microphone utilizing an optical sensor according to the twenty ninth aspect.

A thirty second aspect of the present invention is a portable communication device utilizing an optical sensor according to the twenty ninth aspect.

A thirty third aspect of the present invention is a method of manufacturing a detection-membrane with a support according to the fifteenth aspect, comprising a release layer formation step for providing a release layer on a substrate, a lamination step for laminating a detection-membrane on top of the release layer and providing a detection-membrane support on the top of the detection-membrane, and a release layer removal step for removing the release layer.

A thirty fourth aspect of the present invention is a method of manufacturing a detection-membrane with a support according to the thirty third aspect, wherein the release layer is formed from a material which is substantially unchanged by the lamination step, and moreover can be removed in the release layer removal step without any substantial changes in the detection-membrane and the support.

A thirty fifth aspect of the present invention is a method of manufacturing a detection-membrane with a support according to the thirty third aspect, wherein the aforementioned release layer is formed from a polyvinyl alcohol resin, and is removed in the release layer removal step by dissolution in water.

A thirty sixth aspect of the present invention is a method of manufacturing a detection-membrane with a support according to the thirty third aspect, wherein the support is formed by laminating a support formation layer on top of the detection-membrane and then etching the support formation layer during the lamination step.

A thirty seventh aspect of the present invention is a method of manufacturing a detection-membrane with a support according to the fifteenth aspect, comprising a step for laminating a detection-membrane on top of a support formation layer, and a step for etching the support formation layer and forming a support.

A thirty eighth aspect of the present invention is a detection-membrane with a support in which a support for supporting the periphery of the detection-membrane is provided on at least one side of the detection-membrane, and the support has a movable section at the joint with the detection-membrane which can move in accordance with vibration of the detection-membrane.

A thirty ninth aspect of the present invention is a detection-membrane with a support according to the thirty eighth aspect, wherein the support has a protruding section protruding into the center of the detection-membrane with a length in the direction of the detection-membrane thickness which gradually decreases towards the center, and the protruding section functions as the aforementioned movable section.

A fortieth aspect of the present invention is a detection-membrane with a support according to the thirty eighth aspect, wherein the aforementioned movable section is formed from an elastic material.

A forty first aspect of the present invention is a detection-membrane with a support according to the fortieth aspect, wherein the movable section is formed from a single crystal material.

A forty second aspect of the present invention is a detection-membrane with a support according to the forty first aspect, wherein the single crystal material is any one of the materials selected from the group consisting of Si, GaAs, GaAlAs, GaP, InP and Al₂O₃.

A forty third aspect of the present invention is a detection-membrane with a support according to the fortieth aspect, wherein the aforementioned movable section is formed from a metal.

A forty fourth aspect of the present invention is a detection-membrane with a support according to the forty third aspect, wherein the aforementioned metal is selected from the group consisting of Al, Ni, Cu, Fe and Mg, or alternatively is formed from an alloy comprising at least one metal selected from the same group.

A forty fifth aspect of the present invention is a detection-membrane with a support according to the fortieth aspect, wherein the aforementioned movable section is formed from a synthetic resin.

A forty sixth aspect of the present invention is a detection-membrane with a support according to the forty fifth aspect, wherein the synthetic resin is formed from either one, or two or more, of the materials selected from the group consisting of polyimides, fluororesins, epoxy resins, synthetic rubbers, polystyrene, bakelite, polyethylene and polypropylene.

A forty seventh aspect of the present invention is an optical sensor comprising a detection-membrane with a support according to the thirty eighth aspect, a light emitting element for irradiating light onto the detection-membrane supported by the support, and a light receiving element for receiving reflected light reflected off the detection-membrane.

A forty eighth aspect of the present invention is an optical sensor according to the forty seventh aspect, wherein the light emitting element and the light receiving element are positioned on the same side of the detection-membrane.

A forty ninth aspect of the present invention is a portable communication device utilizing an optical sensor according to the forty seventh aspect.

A fiftieth aspect of the present invention is a microphone utilizing an optical sensor according to the forty seventh aspect.

A fifty first aspect of the present invention is a method of manufacturing a detection-membrane with a support according to the thirty eighth aspect, wherein the support is formed by laminating a support formation layer on top of the detection-membrane and then etching the support formation layer.

A fifty second aspect of the present invention is a method of manufacturing a detection-membrane with a support according to the thirty eighth aspect, wherein the support is formed by laminating the detection-membrane on top of a support formation layer and then etching the support formation layer.

According to the present invention, a detection-membrane can be provided in which either the mechanical strength or the environmental resistance characteristics, or preferably both such characteristics, have been improved, and an optical sensor which utilizes such a detection-membrane can also be provided. As a result, an optical sensor can be provided which displays good strength, high sensitivity, a superior S/N ratio, and good environmental resistance characteristics, and which is preferably small in size.

### BRIEF DESCRIPTION OF THE DRAWINGS

FIG. 1 is a cross-sectional view showing one example of an optical sensor of the present invention.

FIG. 2 is a plan view showing the optical sensor shown in FIG. 1.

FIG. 3 is a cross-sectional view showing one example of a detection-membrane of the present invention.

FIG. 4 is a cross-sectional view showing another example of a detection-membrane of the present invention.

FIG. 5 is a cross-sectional view showing another example of an optical sensor of the present invention.

FIG. 6 is a cross-sectional view showing a laminating process in one example of a method of manufacturing a detection-membrane with a support according to the present invention.

FIG. 7 is a cross-sectional view showing a method of forming a support in one example of a method of manufacturing a detection-membrane with a support according to the present invention.

FIG. 8 is a cross-sectional view showing a release layer removal process in one example of a method of manufacturing a detection-membrane with a support according to the present invention.

### DETAILED DESCRIPTION OF THE PREFERRED EMBODIMENTS

An optical sensor is a device in which light is irradiated onto the surface of a detection-membrane which displaces (vibrates) under the application of a physical change such as acceleration, pressure or sound waves, and reflected light off the membrane is then used to measure the displacement magnitude of the detection-membrane.

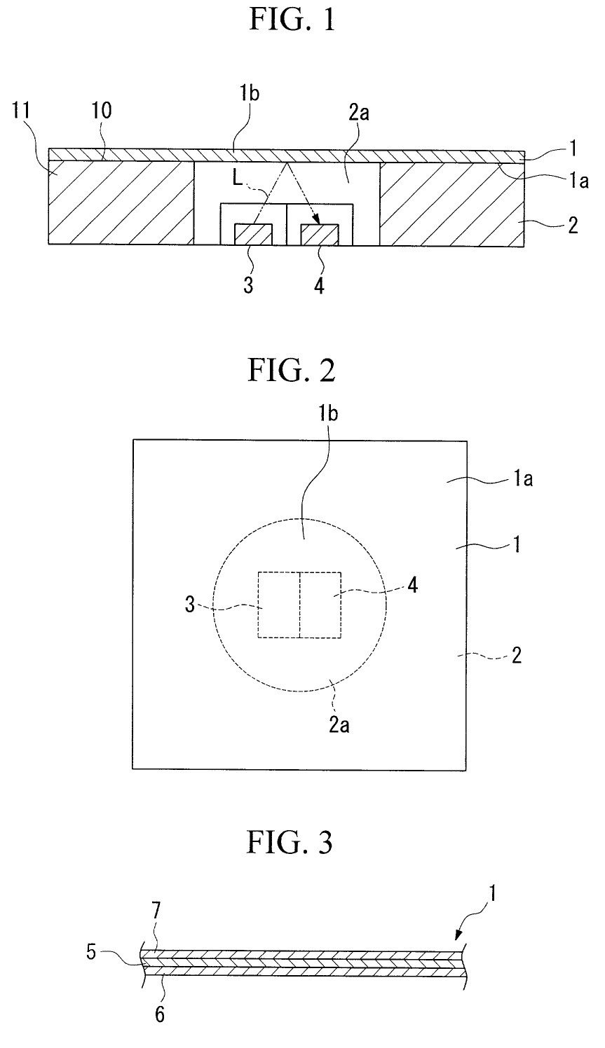

FIG. 1 is a cross-sectional view showing one example of an optical sensor of the present invention, and FIG. 2 is a plan view showing the optical sensor shown in FIG. 1.

In the figures, the numeral 1 represents a detection-membrane 1. A periphery section 1a of the detection-membrane 1 is bonded to, and supported by, the upper surface of a support 2 with a cylindrical hollow section (an aperture section) 2a which passes through the support from top to bottom. The combination of the detection-membrane 1 and the support 2 forms a detection-membrane with a support. The external shape of the support 2 is a rectangular solid. A light emitting element 3 and a light receiving element 4 are provided in the hollow section 2a beneath an unsupported section 1b of the detection-membrane 1 in the central region thereof. From the viewpoint of improving sensitivity, only the light emitting element 3 and the light receiving element 4 are provided at the rear surface of the unsupported section 1b not supported by the support 2. Furthermore, provided the light emitting element 3 and the light receiving element 4 are provided on the same side relative to the detection-membrane 1, then there are no particular restrictions on the positioning of the light emitting element 3 and the light receiving element 4.

In such an optical sensor, when light L is irradiated from the light emitting element 3 onto the surface of the detection-membrane 1, light reflected off the surface of the detection-membrane 1 is received by the light receiving element 4. The displacement magnitude of the detection-membrane 1 is then detected based on this reflected light. Examples of suitable methods for detecting this displacement include a method in which the intensity of the reflected light is detected by the light receiving element 4, and a method which utilizes the phase difference between the light emitted from the light emitting element 3 and the reflected light received by the light receiving element 4.

FIG. 3 is a cross-sectional view showing one example of a detection-membrane of the present invention.

This detection-membrane 1 has a three layered construction comprising a light reflective layer 5, and protective layers 6, 7 for the detection-membrane 1 provided on the top and bottom of the light reflective layer 5. The protective layers 6, 7 should preferably increase the mechanical strength of the detection-membrane 1, as well as prevent corrosion of the light reflective layer 5 in those cases where the light reflective layer 5 is formed from a comparatively corrosion susceptible material.

A construction in which only one of the protective layers 6, 7 is provided is also possible, although providing protective layers on both the top and the bottom of the light reflective layer 5, as in the example shown, is preferable in terms of improving the strength and the environmental resistance characteristics of the detection-membrane 1. The provision of protective layers on both the top and the bottom of the light reflective layer 5 is particularly desirable in those cases where the light reflective layer 5 is formed from a comparatively corrosion susceptible material. Furthermore, from the viewpoint of improving the environmental resistance characteristics, the protective layers 6, 7 should preferably be the outermost layers of the detection-membrane 1. The thickness of, and the materials used in, the two protective layers 6, 7 may be either the same or different.

Furthermore, provided there are no deleterious effects on the light reflective function, at least one layer of the detection-membrane 1 may be colored, and an irregular surface may also be formed on the surface of the detection-membrane 1.

The light reflective layer 5 should preferably be a layer which by reflecting light of a wavelength of 0.3 to 1.7 μm emitted from the light emitting element 3 of a typical optical sensor, is able to produce reflected light of an intensity level which can be detected by the light receiving element 4.

In this example, provided the light reflective layer 5 has an appropriate elasticity, and has a function for reflecting light of the type described above, then there are no particular restrictions on the material for the light reflective layer 5. Suitable materials include metal layers, and layers of synthetic resin with metallic particles dispersed therein.

The metal layers or metallic particles described above should preferably be selected from the group consisting of Al, Ni, Cu, Fe, Mg, Au, Ti, Cr, Co, Ba, Si, Ag and Pt, or alternatively formed from an alloy comprising at least one metal selected from this same group of metals. From the viewpoint of obtaining good sensitivity and a good S/N ratio relative to vibrations of 0 to 100 MHz, reflective layers 5 formed from a metal selected from the group consisting of Al, Ni, Cu, Fe, Mg, Au, Ti, Cr, Co, Ba and Si, or alternatively formed from an alloy comprising at least one metal selected from this same group of metals, are preferred.

Surfaces treated with dispersants, synthetic resins or other metals or the like may also be used for the metallic particles described above.

Furthermore, provided these metallic particles have an average particle diameter which is less than the thickness of the light reflective layer 5 and do not impair the light reflectivity of the light reflective layer 5, then there are no particular restrictions on the metallic particles. If the average particle diameter is greater than the thickness of the light reflective layer 5 then there is a danger of the entire detection-membrane 1 losing uniformity, whereas if the average particle diameter is less than the light wavelength used, then there is a danger that the light reflectivity will be insufficient. Furthermore, the proportion of metallic particles incorporated within the light reflective layer 5 will depend on the combination with the synthetic resin described below, although values between 50 and 95% by weight are preferable. At values less than 50% by weight, the light reflectivity will deteriorate, whereas at values exceeding 95% by weight, binding the metallic particles with the synthetic resin becomes difficult, and there is a danger of the metallic particles separating from the light reflective layer 5, either in those steps in the manufacturing process following the formation of the light reflective layer 5, or during actual use of the detection-membrane 1.

Examples of suitable synthetic resins for dispersing the aforementioned metallic particles include hydrocarbon based resins, acrylic acid based resins, vinyl acetate based resins, vinyl alcohol based resins, halogenated resins, nitrogen containing vinyl polymers, diene based polymers, polyether based resins, polyethylene imine based resins, phenol based resins, amino resins, aromatic hydrocarbon based resins, polyester based resins, polyamide based resins, silicon based resins, furan resin, polysulfide based rubbers, polyurethane based resins, polyurea based resins, epoxy based resins, cellulose and derivatives thereof, proteins and silicon dioxide etc., and such materials can be used singularly, or in combinations of two or more materials.

In terms of improving strength and environmental resistance characteristics, the synthetic resin should also preferably be a setting resin. Setting here refers to the formation of intermolecular cross linking through the irradiation of light or heat, such as ultraviolet light or an electron beam.

Examples of suitable setting resins include vinyl based setting resins, epoxy based setting resins, urethane based setting resins, silicone based setting resins and silicon dioxide based setting resins. More specifically, suitable setting resins include (meth)acrylic acid ester based ultraviolet setting resins (where the term (meth)acrylic acid represents either methacrylic acid or acrylic acid), thermal radical polymerization setting resins of unsaturated polyester based resins, setting resins formed from epoxy and amine materials, and setting resins formed from polyol and polyisocyanate materials. Such resins can be used singularly, or in any arbitrary combinations of two or more resins.

Moreover, synthetic resins incorporating various additives can also be used, provided the function of the detection-membrane 1 is not impaired. Examples of additives include ultraviolet absorbers, antioxidants, fluorescent whitening agents, antistatic agents, antifogging agents, pigments, rust prevention agents and foaming agents, or surfactants such as antifoaming agents, wetting agents and leveling agents. Such additives can be selected from commonly known materials, and can be used singularly, or in combinations of two or more such materials.

Furthermore, metal oxides may also be used for the light reflective layer 5, with suitable examples including Al₂O₃, Ba₂O₃, Mg₂O₃ and SiO₂.

The thickness of the light reflective layer 5 is typically from 5×10⁻³ to 2 μm, with values from 5×10⁻² to 1 μm being preferable. If the thickness of the layer exceeds this range, the sensitivity of the optical sensor deteriorates, whereas if the thickness is thinner than this range, there is a danger of a reduction in the light reflectivity and a deterioration in the S/N ratio.

In the detection-membrane 1 of this example, the light reflective layer 5 is the only layer except for the protective layers 6, 7, and so these protective layers 6, 7 protect the light reflective layer 5 from external factors such as physical pressure, temperature and humidity.

Depending on the atmospheric conditions under which the detection-membrane is used, these protective layers 6, 7 may utilize oils such as fatty acids or the esters thereof or surfactants, although environmental resistance tests at 80° C. and 80% humidity suggest that in order to improve reliability even further, materials such as synthetic resins; metals which are comparatively resistant to corrosion such as Au, Cr, Ni, Zr and Pt and the like, or alloys incorporating at least one of these metals; and either one, or both of, SiO₂ and Si₃N₄ are preferable.

Of these materials, synthetic resins are preferable as they enable a stable protective function, are easy to manufacture, and are also able to function as an adhesive layer for the support 2 when provided on the surface facing the support 2.

Suitable synthetic resins include all those synthetic resins described above as being suitable for use in the aforementioned light reflective layer 5 for dispersing the metallic particles. Of these resins, the setting resins described above are preferable from the viewpoint of improving reliability. Furthermore, one, or two or more of the resins selected from the group consisting of polyimides, fluororesins, polyethylene terephthalate and polystyrene are particularly desirable from the viewpoint of improving environmental resistance. As described above, a variety of additives may also be added to the synthetic resins.

The thickness of one layer of the protective layers 6, 7, for example in the case where the layer is formed from metal or SiO₂ and Si₃N₄, should be from 5×10⁻³ to 0.5 μm, with values from 5×10⁻² to 0.4 μm being preferable, and values from 0.1 to 0.3 μm being even more desirable. In the case where the layer is formed from a synthetic resin, values should be from 1×10⁻² to 1 μm, with values from 0.1 to 0.8 μm being preferable.

If the layer is too thick, the sensitivity of the optical sensor deteriorates, whereas if the layer is too thin, there is a danger of a reduction in the protective functions of the layer.

Furthermore, the specific gravity of the detection-membrane 1 should be from 14.5 to 0.5, with values from 5 to 1 being preferable, and values from 3 to 1 being even more desirable. If the specific gravity is greater than this range then there is a danger of a decrease in the sensitivity of the optical sensor, whereas if the specific gravity is less than this range then there is a danger of a decrease in the strength of the detection-membrane. These specific gravity values refer to values measured at 20° C. (the units are dimensionless).

Furthermore, because the detection-membrane 1 is extremely thin, handling of a single detection-membrane is difficult. Consequently, it is preferable that a support 2 is formed on at least one surface of the detection-membrane 1, so that the detection-membrane 1 and the support 2 are handled as an integrated detection-membrane with a support. Using a detection-membrane with a support also improves the ease of manufacture of the detection-membrane 1 markedly.

There are no particular restrictions on the shape and material for the support 2, although an aperture section must be provided at least on the side of the detection-membrane 1 (the light reflective surface side).

There are no particular restrictions on the method for integrating the detection-membrane 1 and the support 2, and suitable methods include bonding the two together using an adhesive, a pressure sensitive adhesive sheet or an adhesive sheet, for example.

In this example, by forming the protective layer 6 on the outermost layer facing the support 2 from a synthetic resin, this protective layer 6 can also fulfil the role of an adhesive layer for bonding the detection-membrane 1 and the support 2 together. By using the protective layer 6 as an adhesive layer in this manner, the construction is simplified, which is preferable.

In terms of suitability for the photolithography or etching methods described below, and ensuring the necessary rigidity, the material for the support 2 should preferably be formed from one, or two or more materials selected from the group consisting of Al, Ni, Cu, Fe, Mg, GaAs, Si, GaP, InP, GaAlAs and Al₂O₃.

Alternatively, a setting resin such as those described above could also be selected.

One example of the size of the support 2 comprises an upper and lower surface with length×width dimensions of 5 mm×5 mm and a height (thickness) of 1 mm, and a hollow section 2a with a diameter of 2 mm.

Furthermore, the thinner and lighter the detection-membrane 1 is made, the greater the physical sensitivity, although considerations of the strength, degree of warping, and optical reflection characteristics of the detection-membrane 1, mean that of course there are limits. In other words, if warping or distortion occurs in the detection-membrane 1, or more particularly in the light reflective layer 5, then displacement of the detection-membrane 1 will cause large discrepancies in the light reflection angle, and so the characteristics of the optical sensor will deteriorate. Furthermore, in relation to the area of the light reflective surface (the unsupported section 1b) of the detection-membrane 1, the more dispersed the light is, the simpler the displacement measurement becomes, although if the area of the light reflective surface is too large, the S/N ratio will deteriorate.

Consequently, taking the above factors into consideration, the thickness of the detection-membrane 1 and the area of the light reflective surface are set within the limits described below. The values below are results obtained from the examination of the sensitivity and the S/N ratio relative to vibrations of 0 to 100 MHz requested of an optical sensor.

The thickness of the detection-membrane 1 should be from 0.01 to 20 μm, with values of 0.01 to 5 μm being preferable. At thickness values less than 0.01 μm, the membrane strength is insufficient, whereas at thickness values more than 20 μm, there is a danger of a reduction in the optical sensor sensitivity.

Furthermore, the surface area of the unsupported section 1b not supported by the support 2 (the area of the light reflective surface) should be from 2×10⁻⁴ to 0.3 cm², with values of 4×10⁻⁴ to 0.13 cm² being preferable, and values from 8×10⁻³ to 7×10⁻² cm², being even more desirable. At values outside these ranges measurement becomes difficult, and there is a danger of a reduction in the S/N ratio.

By using a detection-membrane with a support which satisfies the above conditions relating to the thickness of the detection-membrane 1 and the surface area of the unsupported section 1b, an optical sensor can be constructed which is smaller than any conventional devices, and moreover displays good sensitivity and a good S/N ratio.

Furthermore, in a detection-membrane 1 of the present invention, a plurality of light reflective layers 5 can be provided if necessary, and the protective layers 6, 7 could be limited to only one protective layer, or alternatively three or more protective layers could be provided.

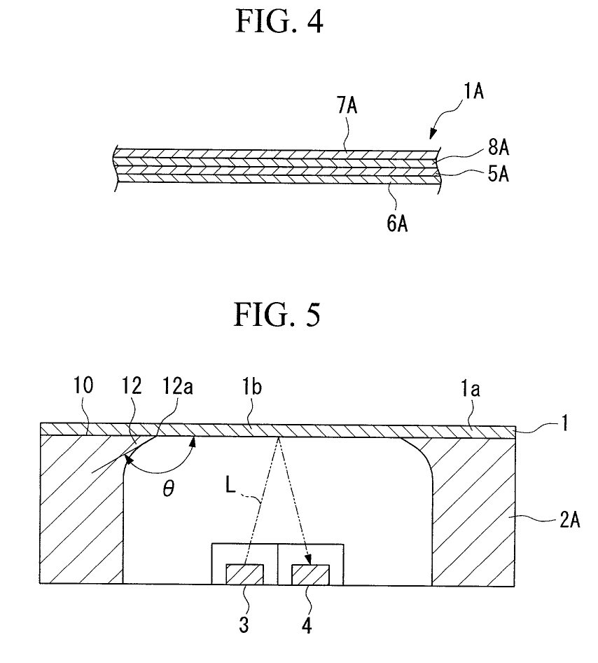

FIG. 4 is a cross-sectional view showing another example of a detection-membrane of the present invention. This detection-membrane 1A has an integrated four layer construction in which an elastic layer 8A is laminated on top of a light reflective layer 5A, a protective layer 6 A is laminated underneath the light reflective layer 5A, and a protective layer 7A is laminated on top of the elastic layer 8A.

The light reflective layer 5A, the protective layer 6 A and the protective layer 7A can be the same as the light reflective layer 5, the protective layer 6 and the protective layer 7 shown in FIG. 3. The elastic layer 8A is provided for improving the elasticity of the detection-membrane 1A, and in terms of obtaining good sensitivity and a good S/N ratio for vibrations of 0 to 100 MHz, should preferably be formed from a metal selected from the group consisting of Al, Ni, Cu, Fe, Mg, Au, Ti, Cr, Co, Ba and Si, or alternatively be formed from an alloy comprising at least one metal selected from the same group. A metallic elastic layer 8A can also function as a light reflective layer. Furthermore, if the elastic layer 8A is formed from metals such as Cr or Ni which are comparatively resistant to corrosion, then the layer can also function as a protective layer. Furthermore, from the viewpoint of sensitivity and the S/N ratio, the elastic layer 8A could also be formed from either one, or two or more, of the synthetic resins selected from the group consisting of polyethylene terephthalate, polystyrene, polyimides and fluororesins. An elastic layer 8A made of a synthetic resin can also function as a protective layer for the detection-membrane 1A. In the case of a metallic elastic layer 8A, the thickness of the layer should be from 5×10⁻ to 2 μm, with values from 5×10⁻² to 1 μm being preferable. When a synthetic resin is used, the thickness of the layer should be from 1×10⁻² to 1 μm, with values from 0.1 to 0.8 μm being preferable. If the layer is too thick the sensitivity deteriorates, whereas if the layer is too thin, the desired effect cannot be sufficiently realized.

Moreover, a detection-membrane or a detection-membrane with a support according to the present invention is able to be used in an optical sensor, as described above. Such optical sensors can be used in microphones and various portable communication equipment. A specific example is the use of such an optical sensor in the microphone of the transmission section of a portable communication device.

A microphone using an optical sensor of the present invention can be miniaturized to a greater extent than conventional condenser type microphones with diameters of 8 mm or 3 mm.

The construction of an optical sensor of the present invention is not limited to the construction shown in FIG. 1, and can be applied to a variety of different embodiments. Furthermore, similarly in the case of microphones and portable communication equipment, an optical sensor of the present invention can also be applied to a variety of known constructions.

Moreover, according to the optical sensor shown in FIG. 1, the support 2 should preferably have a movable section 11, which moves in accordance with vibrations of the detection-membrane 1 and which is provided on the upper surface of the support 2 at the joint section 10 with the detection-membrane 1 (the surface contacting the periphery section 1a of the detection-membrane 1). The movable section 11 is formed from an elastic material. Here, an elastic material refers to a material which when distorted by an external force generates a force to attempt to return the material to the original state.

This movable section 11 causes a force applied to the detection-membrane 1 to be absorbed and dispersed by the support 2. As a result, the strength of the detection-membrane 1 improves, and so the detection-membrane 1 can be made even thinner, enabling a highly sensitive optical sensor to be produced.

In such cases, the entire support 2 can be constructed of an elastic material, or alternatively a movable section 11 can be provided at the joint section 10 of the support 2, with the remaining sections being formed of a rigid material.

For example, a synthetic rubber based adhesive could be applied to the joint section 10 of the support 2 which contacts the detection-membrane 1, and the movable section 11 formed from this adhesive layer.

Single crystal materials can be used for the elastic material, with one of the materials selected from the group consisting of Si, GaAs, GaAlAs, GaP, InP and Al₂O₃ being preferable. Furthermore, metals can also be used, and specifically a metal selected from the group consisting of Al, Ni, Cu, Fe and Mg, or alternatively an alloy comprising at least one metal selected from the same group, are preferable. In addition, synthetic resins can also be used, with either one, or two or more, of the materials selected from the group consisting of polyimides, fluororesins, epoxy resins, synthetic rubbers, polystyrene, bakelite, polyethylene and polypropylene being preferable.

FIG. 5 is a cross-sectional view showing another example of an optical sensor of the present invention.

The aspect in which this optical sensor differs from the optical sensor shown in FIG. 1 is the shape of the support 2A.

In other words, at the joint section 10 where the upper surface of the support 2A contacts the detection-membrane 1, a protruding section 12 is provided which protrudes towards the center of the detection-membrane 1 (towards the unsupported section 1b), and moreover has a length, in the direction of the thickness of the detection-membrane 1, which gradually decreases towards the aforementioned center. The upper surface of the protruding section 12 forms a single plane with the upper surface of the support 2A, and is bonded to, and integrated with the detection-membrane 1. In other words, the shape of the protruding section 12 causes the thickness of the support 2A to gradually decrease towards the center of the detection-membrane 1, until eventually only the detection-membrane 1 remains.

By constructing the support 2A in this type of shape, the protruding section 12 is able to move in accordance with vibrations of the detection-membrane 1, producing the same effect as the movable section described above. In other words, the protruding section 12 is the movable section. As a result, the support 2A is able to absorb and disperse the forces resulting from vibration of the detection-membrane 1. Consequently, even if the detection-membrane 1 is made thinner and the sensitivity of the optical sensor is improved, an optical sensor can be achieved in which damage to the detection-membrane 1 is unlikely.

At the tip 12a of the protruding section 12, the angle with which a line passing through this tip section 12a contacts the surface of the detection-membrane 1 is 0 degrees. Then, as this line is moved towards the support 2A in the shape of a circle about a central point at the tip 12a, the angle where the line first contacts the support 2A is termed θ. In this specification, there are cases where this angle θ is the angle between the support 2A and the detection-membrane 1.

The shape of the protruding section 12 is formed so that the angle θ is an obtuse angle. Obtuse here refers to angles from 90 to 180 degrees. If the angle θ is too small, the protective effect on the detection-membrane 1 diminishes, whereas if the angle θ is too large, the support 2A is more easily damaged by vibration of the detection-membrane 1, and so the reliability of the optical sensor deteriorates. Consequently, although dependent on the material used for the support 2A and the strength thereof, the angle θ should preferably be from 110 to 175 degrees, with angles from 135 to 175 degrees being even more desirable, and angles from 150 to 175 degrees being the most ideal.

Furthermore, the protruding section 12 should preferably be formed from an elastic material such as those described in relation to the material for the movable section 11 shown in FIG. 1. For example, a synthetic rubber adhesive could be applied to the joint section 10 of the support 2 shown in FIG. 1 with no protruding section, on the surface where the joint section 10 contacts the detection-membrane 1, and this adhesive layer then worked into the shape of the protruding section 12 shown in FIG. 5. Furthermore, providing a movable section 11 formed from an elastic material at the joint section 10 (as shown in FIG. 1) in addition to the protruding section 12 is even more desirable.

According to a detection-membrane with a support and a detection-membrane with a support and a protruding section, which are provided with movable sections such as the movable section 11 of FIG. 1 or the protruding section 12 shown in FIG. 5 respectively, the mechanical strength of a detection-membrane and an optical sensor using such a detection-membrane can be improved, whether the detection-membranes shown in FIG. 3 and FIG. 4 are used, or even if other detection-membranes are used.

As follows is a description of a sample method of manufacturing a detection-membrane with a support according to the present invention.

As shown in FIG. 1 and FIG. 2, a detection-membrane with a support can be produced by preparing a support 2 with an aperture section 2a in advance, and then integrating the support 2 and the detection-membrane 1 together with an adhesive or the like. Alternatively, a detection-membrane with a support may also be produced by preparing a support formation layer in which an aperture section 2a has not be formed, forming a detection-membrane 1 on one surface of the support formation layer and integrating the two together, and subsequently completing the support 2 by forming an aperture section 2a by partial etching of the support formation layer on the opposite surface to where the detection-membrane 1 is formed.

In this etching process, if the etching is halted so that the joint section between the detection-membrane 1 and the support 2 is an obtuse angle, then a protruding section 12 such as that shown in FIG. 5, which moves in accordance with vibrations of the detection-membrane 1, can be formed.

The methods described below can also be suitably applied.

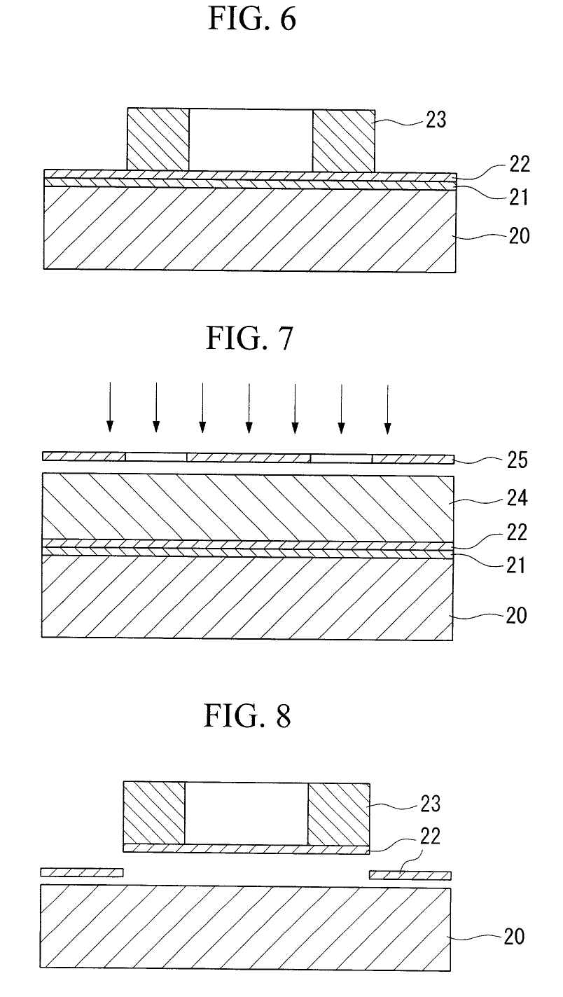

First, as shown in FIG. 6, a release layer 21 is provided on the mirror surface of a substrate 20 (a release layer formation process). There are no particular restrictions on the material for, or the thickness of the substrate 20, provided at least one surface of the substrate 20 is a mirror surface. Suitable materials include a glass substrate or a silicon substrate. The release layer 21 is described below.

Subsequently, a detection-membrane 22 is laminated on top of the release layer 21. The detection-membrane 22 can be formed using various methods such as vacuum deposition, CVD methods, sputtering methods, rolling methods, spin coating and application methods, with the method chosen dependent on each of materials of the layers comprising the detection-membrane 22.

Then, a support 23 is provided on top of the detection-membrane 22, and the detection-membrane 22 and the support 23 are integrated (a lamination process). The integration of the detection-membrane 22 and the support 23 can be performed using an adhesive or an adhesive sheet or the like, although in those cases where the outermost protective layer of the detection-membrane 22 nearest the support 23 is made from a synthetic resin, this outermost layer can be used as an adhesive layer.

The support 23 may comprise a predetermined shape which has been processed in advance, such as that shown in FIG. 6, or may be formed by processing a support formation layer 24 as shown in FIG. 7. For example, a support formation layer 24 could be laminated on top of the detection-membrane 22 and a protective layer 25 laminated on top of the support formation layer 24, photolithography or the like then used to form a circular pattern section, and etching then performed on this pattern section to produce an aperture section and complete the support 23 (the release layer removal process). Examples of suitable methods for forming the aforementioned pattern section and the aperture section include photolithography using a photosensitive resin, a method in which a template with a preformed pattern is attached, and a method in which following formation of the protective layer, a lathe, a drill or an end mill is used for additional mechanical processing. Furthermore, in the case of etching, either wet process methods using a predetermined solvent, or gas phase methods using a plasma or the like, can be used.

Furthermore, as described above, the support formation layer 24 can also be formed from at least one of the resins selected from the group consisting of vinyl based setting resins, epoxy based setting resins, urethane based setting resins, silicone based setting resins and silicon dioxide based setting resins. In such cases, the detection-membrane 22 and the support formation layer 24 can be integrated together without the use of a separate adhesive. In those cases where the support formation layer 24 is formed from an ultraviolet setting resin, because only those sections irradiated with ultraviolet light will cure and harden, the remaining sections can be removed using a suitable solvent to form the aperture section and complete the support 23.

In the etching processing, if the etching is halted so that the joint section between the detection-membrane 22 and the support 23 is an obtuse angle, then a protruding section 12 such as that shown in FIG. 5, which moves in accordance with vibrations of the detection-membrane 1, can be formed.

Then, as shown in FIG. 8, if cuts are made in the detection-membrane 22 along extensions of the outer edges of the support 23, and a suitable solvent or the like is subsequently used to dissolve and remove the release layer 21, then the detection-membrane 22 can be removed from the substrate 20, producing a detection-membrane with a support.

By providing a release layer 21 on top of a substrate 20, laminating a detection-membrane 22 on to the release layer 21, integrating a support 23 with the detection-membrane 22, and then separating the detection-membrane 22 and the substrate 20 by using the action of the release layer 21 in this manner, the handling of extremely thin detection-membranes 22 is simplified, and the ease of manufacture can be improved markedly.

The release layer 21 should preferably be formed from a material which undergoes no substantial changes during the aforementioned lamination process, and moreover is able to be removed in the aforementioned removal layer removal process without causing any substantial changes to the detection-membrane 22 and the support 23.

For example, it is preferable that the support formation layer 24 is formed from an uncured ultraviolet light setting resin, and that the release layer 21 is insoluble (is substantially unchanged) in the solvent used for forming the support 23 by removing the uncured sections of the support formation layer 24 after irradiation with ultraviolet light, and moreover that the materials comprising the support 23 and the detection-membrane 22 are insoluble (substantially unchanged) in the solvent used for removing the release layer 21. It is also a requirement that the detection-membrane 22 is substantially unchanged, during the removal of the uncured sections.

For example, if the detection-membrane 22 and the support 23 are formed from materials which are insoluble in polar solvents and soluble in nonpolar solvents, and the release layer 21 is formed from a material which is soluble in polar solvents and insoluble in nonpolar solvents, the conditions described above can be satisfied.

Amongst the various combinations of materials for the release layer 21 and the solvent used for removing this release layer 21, polyvinyl alcohol resins are preferred as the material for the layer, and water the preferred solvent. Polyvinyl alcohol resins are typically only soluble in water or aqueous alcohol solutions comprising water as the major constituent, and are almost completely insoluble in general purpose organic solvents such as alcohols, esters, ketones, hydrocarbons and aromatic hydrocarbons. As a result, the range of materials which can be used for the detection-membrane 22 and the support 23 can be broadened considerably. Furthermore, because polyvinyl alcohol resins display superior film forming properties, the quality of the surface of the produced detection-membrane 22 is also superior. Examples of suitable polyvinyl alcohol resins include copolymers of a monomer such as fully saponified polyvinyl alcohol, partially saponified polyvinyl alcohol, or an anionic or cationic denatured polyvinyl alcohol thereof, with another monomer such as N-vinylacetamide, acrylamide or vinylpyrrolidone. Of these, partially saponified polyvinyl alcohol or anionic denatured polyvinyl alcohol with saponification ratios of 86 to 90 mol % are preferable as they display very high solubility in water, and low solubility in other solvents. Moreover, polyvinyl alcohol resins comprising various additives can also be used, provided they cause no deleterious effects on the properties of the release layer 21. Such additives can be selected from known additives, and may be used singularly, or in combinations of two or more such additives. Specific examples include surfactants such as antifoaming agents, wetting agents and leveling agents, as well as pigments.

### EXAMPLES

As follows is a more detailed description of the present invention based on a series of examples. Needless to say, the present invention is not limited to these examples.

### Examples 1 to 23, and Experimental Examples 1 to 3

Using the detection-membrane with a four layer construction shown in FIG. 4 as a base, 2 to 4 layer detection-membranes with a support were produced.

Specifically, each detection-membrane was formed directly on top of a support formation layer, using a method appropriate for the material used, such as vacuum deposition, a CVD method, sputtering, spin coating or an application method. A photosensitive resin was then applied to the opposite surface of the support formation layer to the detection-membrane, forming a resin layer. Photolithography was used to form a circular pattern section in this resin layer. The resin layer was immersed in an acid based etching solution, and etching used to dissolve the aforementioned circular pattern section and form an aperture section, thereby completing the formation of the support and yielding a detection-membrane with a support.

The material used for the support, the materials used for each of the layers of the detection-membrane and the thickness of each of those layers, the area of the unsupported section (the light reflective surface), and the total thickness and specific gravity of the detection-membrane are recorded in Table 1.

In the examples 2, 16 and 17, an elastic layer functions as a protective layer.

Each of the detection-membranes with a support was applied to the optical sensor shown in FIG. 1, which was then used to manufacture a microphone. Each microphone was then evaluated for sensitivity, S/N ratio, and environmental resistance under conditions of 80° C. and 80% humidity, relative to sound waves of 1 to 20 kHz. The results of the evaluations are shown in Table 2.

TABLE 1

| | | | | | | Protective | | | | Area of the | | |
|---|---|---|---|---|---|---|---|---|---|---|---|---|
| | | | | Light | | layer (light | | Protective | | Unsupported | | Specific |
| | | | | reflective | | reflective | | layer (elastic | | section (light | | gravity of |
| | | Elastic layer | | layer | | layer side) | | layer side) | | reflective | Total | the entire |
| | | | Thickness | | Thickness | | Thickness | | Thickness | surface) | thickness | membrane |
| | Support | Material | μm | Material | μm | Material | μm | Material | μm | cm² | μm | (20° C.) |
| Example | | | | | | | | | | | | |
| 1 | Al | Ni | 0.2 | Au | 0.1 | — | — | Au | 0.1 | 0.062 | 0.40 | 14.0 |
| 2 | Al | Ni | 0.8 | Au | 0.1 | — | — | — | — | 0.071 | 0.90 | 10.1 |
| 3 | Al | Al | 2.5 | Au | 0.1 | — | — | SiO₂ | 0.4 | 0.196 | 3.00 | 3.2 |
| 4 | Al | Ti | 1.8 | Au | 0.2 | — | — | Au | 0.2 | 0.126 | 2.20 | 7.2 |
| 5 | Al | Al | 0.4 | Pt | 0.1 | — | — | Pt | 0.1 | 0.018 | 0.60 | 8.9 |
| 6 | Cu | Al | 3.0 | Al₂O₃ | 0.5 | — | — | Si₃N₄ | 0.3 | 0.264 | 3.80 | 2.9 |
| 7 | Cu | Mg | 1.0 | Au | 0.2 | — | — | Au | 0.2 | 0.119 | 1.40 | 6.8 |
| 8 | Si | Ni | 0.8 | Au | 0.3 | — | — | Au | 0.1 | 0.031 | 1.20 | 12.4 |
| 9 | Si | Ni | 1.5 | Ag | 0.2 | SiO₂ | 0.1 | — | — | 0.096 | 1.80 | 8.7 |
| 10 | Si | Al | 2.0 | — | — | SiO₂ | 0.3 | SiO₂ | 0.3 | 0.159 | 2.60 | 2.6 |
| 11 | Si | Al | 0.4 | Au | 0.1 | — | — | Si₃N₄ | 0.5 | 0.08 | 1.00 | 4.5 |
| 12 | Si | Al | 2.7 | Au | 0.3 | — | — | Si₃N₄ | 0.5 | 0.145 | 3.50 | 4.2 |
| 13 | Si | Cr | 1.8 | Mg₂O₃ | 0.5 | — | — | Pt | 0.1 | 0.091 | 2.40 | 6.6 |
| 14 | Si | Si | 2.0 | SiO₂ | 0.3 | — | — | Au | 0.1 | 0.126 | 2.40 | 3.0 |
| 15 | Si | polyst- | 1.8 | Au | 0.1 | — | — | Au | 0.1 | 0.159 | 2.00 | 2.9 |
| | | yrene | | | | | | | | | | |
| 16 | Si | polyst- | 1.8 | Al | 0.3 | — | — | — | — | 0.166 | 2.10 | 1.3 |
| | | yrene | | | | | | | | | | |
| 17 | Si | poly- | 3.0 | SiO₂ | 0.2 | — | — | — | — | 0.283 | 3.20 | 1.4 |
| | | imide | | | | | | | | | | |
| 18 | Si | fluoro- | 1.2 | Ni | 0.3 | SiO₂ | 0.2 | — | — | 0.08 | 1.70 | 3.0 |
| | | resin | | | | | | | | | | |
| 19 | GaAs | Al | 0.3 | Au | 0.1 | — | — | fluoro- | 0.2 | 0.025 | 0.60 | 5.1 |
| | | | | | | | | resin | | | | |
| 20 | GaAs | Al | 0.4 | Cu | 0.2 | SiO₂ | 0.1 | Au | 0.1 | 0.057 | 1.00 | 5.5 |
| 21 | GaAs | Al | 0.2 | Al₂O₃ | 0.3 | — | — | Au | 0.1 | 0.071 | 0.60 | 6.1 |
| 22 | GaAs | Ti | 0.3 | Ni | 0.1 | Si₃N₄ | 0.3 | — | — | 0.0119 | 0.70 | 4.5 |
| 23 | GaAs | Ti | 1.0 | Ba | 0.3 | fluoro- | 0.2 | — | — | 0.113 | 1.50 | 4.0 |
| | | | | | | resin | | | | | | |
| Experimental | | | | | | | | | | | | |
| examples | | | | | | | | | | | | |
| 1 | Al | Ni | 2.0 | Au | 0.1 | — | — | Au | 0.1 | 0.31 | 2.20 | 9.9 |
| 2 | Al | Al | 0.4 | Pt | 0.1 | — | — | Pt | 0.1 | 0.0001 | 0.60 | 8.9 |
| 3 | Si | polyst- | 1.8 | Au | 0.1 | — | — | Au | 0.1 | 0.32 | 2.00 | 2.9 |
| | | yrene | | | | | | | | | | |

TABLE 2

| | | | Environmental |
|---|---|---|---|
| | Sensitivity | S/N ratio | resistance |
| Examples | | | |
| 1 | A | A | B |
| 2 | B | A | B |
| 3 | C | B | B |
| 4 | B | C | A |
| 5 | B | A | A |
| 6 | C | B | B |
| 7 | B | B | A |
| 8 | B | B | B |
| 9 | B | B | C |
| 10 | C | B | B |
| 11 | A | B | B |
| 12 | B | B | B |
| 13 | C | C | A |
| 14 | C | B | B |
| 15 | B | A | A |
| 16 | C | B | B |
| 17 | C | B | C |
| 18 | B | C | B |
| 19 | A | B | A |
| 20 | B | A | B |
| 21 | B | B | B |
| 22 | B | C | B |
| 23 | C | B | B |
| Experimental | | | |
| examples | | | |
| 1 | D | D | B |
| 2 | D | D | A |
| 3 | D | D | A |

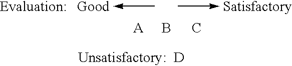

In each of the examples 1 to 23, because the area of the unsupported section falls within the preferred range, the sensitivity and S/N ratio were substantially superior to those of the experimental examples 1 to 3.

Furthermore, because each of the examples 1 to 23 and the experimental examples 1 to 3 has either a protective layer or an elastic layer with a protective function, the environmental resistance results were generally good.

### Examples 24 to 29, and Comparative Example

Detection-membranes with a support were prepared with the detection-membrane of three layer construction shown in FIG. 3, in the manner described below.

Furthermore, the material used for the support, the materials used for each of the layers of the detection-membrane and the thickness of each of those layers, the area of the unsupported section (the light reflective surface), and the total thickness and specific gravity of the detection-membrane are recorded in Table 3.

The high molecular weight compositions shown in Table 3 are as described below.

Vinyl based setting resin 1:

4 parts by weight of Irgacure 184 (manufactured by Ciba Specialty Chemicals K.K.)

100 parts by weight of EB 1290K (manufactured by DAICEL-UCB COMPANY, Ltd.)

589 parts by weight of n-butyl acetate (guaranteed reagent super fine grade)

Vinyl based setting resin 2:

4 parts by weight of Irgacure 184 (manufactured by Ciba Specialty Chemicals K.K.)

100 parts by weight of EB1290K (manufactured by DAICEL-UCB COMPANY, Ltd.)

1976 parts by weight of n-butyl acetate (guaranteed reagent super fine grade)

Urethane based setting resin 1:

Main constituent: 167 parts by weight of Paraloid AU 608S (manufactured by Rohm and Haas Ltd., solid component of 60% by weight)

Setting agent (Curing agent): 34 parts by weight of Duranate THA-100 (manufactured by Asahi Chemical Industry Co.,)

Solvent: 1139 parts by weight of n-butyl acetate (guaranteed reagent super fine grade)

Epoxy based setting resin 1:

Main constituent: 100 parts by weight of Epikote 828 (manufactured by Yuka Shell Epoxy K.K.)

Setting agent (Curing agent): 10 parts by weight of Adeka Hardner EHC-30 (manufactured by Asahi Denka Kogyo K.K.)

Solvent: 990 parts by weight of n-butyl acetate (guaranteed reagent super fine grade)

Vinyl based setting resin 3 (support):

Polymerization initiator: 1 part by weight of Irgacure 184 (manufactured by Ciba Specialty Chemicals K.K.)

Polymerization initiator: 0.3 parts by weight of Irgacure 819 (manufactured by Ciba Specialty Chemicals K.K.)

Radical polymerizable high polymer: 85 parts by weight of KAYARD DPCA-10 (manufactured by Nippon Kayaku Ltd.)

Radical polymerizable high polymer: 15 parts by weight of light acrylate 1.9ND-A (manufactured by Kyoeisha Chemical Co., Ltd.)

Silica: 400 parts by weight of silica with an average particle diameter of 3 μm.

In the vinyl based setting resin 3, no solvent was used.

### Example 24

First, a release layer of partially saponified polyvinyl alcohol (brand name: PVA-217, manufactured by Kuraray Co., Ltd.) was formed on top of a glass substrate, and a protective layer was then formed thereon by applying a polystyrene resin.

Subsequently, a light reflective layer of Al was formed on the protective layer by vacuum deposition.

A polystyrene resin was then applied to the top of the light reflective layer, forming a protective layer and completing the preparation of a detection-membrane.

A cyanoacrylate based adhesive was then applied to one surface of a support, which was crimped and bonded onto the aforementioned detection-membrane. The support used was made of Al, with length×width×height (thickness) dimensions of 5 mm×5 mm×1 mm, and a hollow section (an aperture section) diameter of 2 mm.

The aforementioned release layer was then removed in water, to yield a detection-membrane with a support.

### Examples 25, 26, 28 and 29

Detection-membranes with a support were prepared in the same manner as the example 24, with only the materials used for the two protective layers being different.

Namely, the vinyl based setting resin 1 and the vinyl based setting resin 2 were applied by spin coating, and following drying and removal of the solvent, were irradiated with ultraviolet light to cure the resin and complete the formation of the protective layer.

The urethane based setting resin 1 was applied by spin coating, and following drying and removal of the solvent, a support was crimped to the surface of the resin, and the composition was heated for one hour in a 110° C. oven to cure the resin and complete the formation of the protective layer.

The epoxy based setting resin 1 was applied by spin coating, and following drying and removal of the solvent, a support was crimped to the surface of the resin, and the composition was heated for one hour in a 110° C. oven to cure the resin and complete the formation of the protective layer.

### Example 27

A detection-membrane with a support was prepared in the same manner as the example 25, with the exception that the support was formed from the vinyl based setting resin 3 in the manner described below.

In other words, a release layer and a detection-membrane were formed on top of a glass substrate in the manner described above, and following application of the vinyl based setting resin 3 onto the detection-membrane to form a layer of thickness 0.5 mm, ultraviolet light was irradiated through a mask onto the resin. The mask used enabled the ultraviolet light to be irradiated onto an area with length×width dimensions of 5 mm×5 mm to form a support, and prevented ultraviolet irradiation onto a central area of diameter 2 mm which formed an aperture section.

Then, by removing the uncured section which had not been irradiated with ultraviolet light by dissolution in acetone, a support with an aperture section was formed, completing the preparation of a detection-membrane with a support.

### Comparative Example

A detection-membrane with a support was prepared in the same manner as the example 24, with the exception that the detection-membrane was formed from only a light reflective layer of thickness 0.3 μm. The area of the unsupported section (the light reflective surface) was 0.03 cm², and the specific gravity of the entire detection-membrane at 20° C. was 2.7.

TABLE 3

| | | | | | | | | Area of the | | Specific |
|---|---|---|---|---|---|---|---|---|---|---|
| | | | | Light reflective | | Protective layer | | unsupported | | gravity of |
| | | Protective layer | | layer | | (support side) | | section (light | Total | the entire |
| | | | Thickness | | thickness | | thickness | reflective | thickness | membrane |
| Example | Support | Material | μm | material | μm | material | μm | surface) cm² | μm | (20° C.) |
| 24 | Al | Poly- | 0.15 | Al | 0.025 | poly- | 0.15 | 0.03 | 0.33 | 1.2 |
| | | styrene | | | | styrene | | | | |
| 25 | Al | Vinyl | 0.15 | Al | 0.025 | Vinyl | 0.15 | 0.03 | 0.33 | 1.4 |
| | | based | | | | based | | | | |
| | | setting | | | | setting | | | | |
| | | resin 1 | | | | resin 1 | | | | |
| 26 | Al | Vinyl | 0.15 | Al | 0.050 | Vinyl | 0.15 | 0.03 | 0.35 | 1.5 |
| | | based | | | | based | | | | |
| | | setting | | | | setting | | | | |
| | | resin 1 | | | | resin 1 | | | | |
| 27 | Vinyl | Vinyl | 0.15 | Al | 0.025 | Vinyl | 0.15 | 0.03 | 0.33 | 1.4 |
| | based | based | | | | based | | | | |
| | setting | setting | | | | setting | | | | |
| | resin 3 | resin 1 | | | | resin 1 | | | | |
| 28 | Al | Vinyl | 0.05 | Al | 0.025 | Urethane | 0.4 | 0.03 | 0.48 | 1.4 |
| | | based | | | | based | | | | |
| | | setting | | | | setting | | | | |
| | | resin 2 | | | | resin 1 | | | | |
| 29 | Al | Vinyl | 0.05 | Al | 0.025 | Epoxy | 0.4 | 0.03 | 0.48 | 1.4 |
| | | based | | | | based | | | | |
| | | setting | | | | setting | | | | |
| | | resin 2 | | | | resin 1 | | | | |

### Evaluation

Each of the detection-membranes with a support was applied to the optical sensor shown in FIG. 1, which was then used to manufacture a microphone. Each microphone was then evaluated for sensitivity, S/N ratio, and environmental resistance under conditions of 80° C. and 80% humidity, relative to sound waves of 1 to 20 kHz. The results of the evaluations are shown in Table 4.

TABLE 4

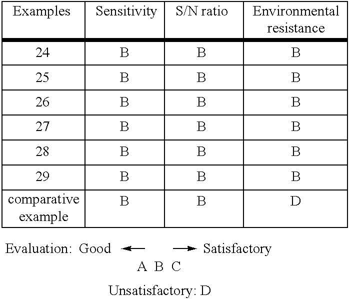

The results shown in Table 4 reveal that in the examples 24 to 29, the environmental resistance in particular had improved markedly.

### Example 30 to 49

A detection-membrane was formed on top of a support formation layer, using a method appropriate for the material used, such as vacuum deposition, sputtering, spin coating or an application method. Following either the bonding of a resin film or a metallic film, or the application of a photosensitive resin, to the opposite surface of the support formation layer to the detection-membrane, photolithography was used to form a circular pattern section for the support. The composition was then immersed in either an acid base etching solution or an organic solvent, and etching used to dissolve the circular pattern section and complete the aperture section, thereby forming a support with a protruding section (a movable section) of the construction shown in FIG. 5, and completing a detection-membrane with a support.

The material used for the movable section (the protruding section) of the support, and the thickness thereof (the maximum thickness of the protruding section), the materials use for each of the layers of the detection-membrane and the thickness of each of those layer, and the angle θ are shown in Table 5.

The diameter of the hollow section (the aperture section) of the support was 3 mm.

TABLE 5

| | | | | | Angle between |
|---|---|---|---|---|---|
| | Movable section | | Detection-membrane | | the support and |
| | Material, thickness | | material, thickness | | the detection- |
| Ex- | | Thickness | | Thickness | membrane θ |
| ample | Material | (μm) | Material | (μm) | (degrees) |
| 30 | Synthetic | 50 | Al | 3 | 170 |
| | rubber | | | | |
| 31 | Synthetic | 50 | Al | 3 | 120 |
| | rubber | | | | |
| 32 | Synthetic | 50 | Al | 3 | 150 |
| | rubber | | | | |
| 33 | epoxy | 200 | Al | 1 | 160 |
| | resin | | | | |
| 34 | epoxy | 180 | Ni | 2 | 100 |
| | resin | | | | |
| 35 | Fluoro- | 300 | Ni | 1 | 140 |
| | resin | | | | |
| 36 | Si | 200 | Al | 3 | 95 |
| 37 | Si | 450 | Al | 3 | 135 |
| 38 | Si | 450 | Al | 3 | 172 |
| 39 | GaAs | 350 | Au/Al/Au | 0.1/2.5/0.1 | 95 |
| 40 | GaAs | 350 | Au/Al/Au | 0.1/2.5/0.1 | 120 |
| 41 | GaAs | 300 | Au/Al/Au | 0.1/3/0.1 | 160 |
| 42 | GaP | 250 | Ni | 4 | 150 |
| 43 | InP | 300 | Ni | 2 | 130 |
| 44 | GaAlAs | 80 | Ni | 2 | 155 |
| 45 | Al | 30 | Au | 0.8 | 95 |
| 46 | Al | 50 | Au | 0.8 | 120 |
| 47 | Cu | 500 | Au/Al | 0.1/1.5 | 95 |
| 48 | Cu | 700 | Au/Al | 0.1/1.5 | 150 |
| 49 | Ni | 120 | Au | 2 | 165 |

Each of the detection-membranes with a support was applied to the optical sensor shown in FIG. 1, which was then used to manufacture a microphone. The light irradiated from the light emitting element had a wavelength of 870 nm. The sensitivity of each microphone was then measured relative to sound waves of 1 to 20 kHz. The results are shown in Table 6.

TABLE 6

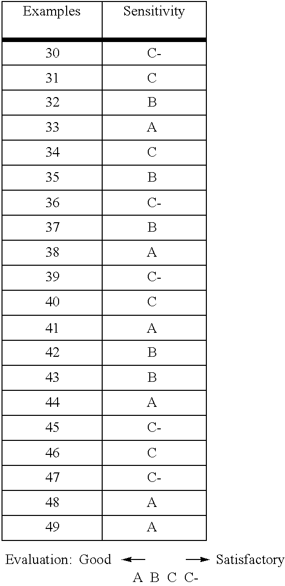

The results of Table 6 reveal a tendency for improved sensitivity for thicker values of the maximum thickness of the protruding section, and for larger values of the angle θ.

What is claimed is:

1. A detection-membrane with a light reflective layer, wherein said detection-membrane has a multilayer construction with a protective layer.

2. A detection-membrane according to claim 1, wherein an outermost layer on either one of one side and both sides of said detection-membrane is said protective layer.

3. A detection-membrane according to claim 1, wherein said protective layer is provided above and below said light reflective layer.

4. A detection-membrane according to claim 1, wherein said light reflective layer is either one of a metallic layer and a synthetic resin layer with metallic particles dispersed therein.

5. A detection-membrane according to claim 4, wherein either one of said metallic layer and said metallic particles are formed from either one of a metal selected from a group consisting of Al, Ni, Cu, Fe, Mg, Au, Ti, Cr, Co, Ba, Si, Ag and Pt, and an alloy comprising at least one metal selected from said group.

6. A detection-membrane according to claim 1, wherein said light reflective layer is formed from a metal oxide compound.

7. A detection-membrane according to claim 6, wherein said metal oxide compound is either one, or two or more compounds selected from a group consisting of Al₂O₃, Ba₂O₃, Mg₂O₃ and SiO₂.

8. A detection-membrane according to claim 1, wherein said protective layer is formed from a synthetic resin.

9. A detection-membrane according to claim 8, wherein said layer is formed from either one, or two or more resins selected from a group consisting of vinyl based setting resins, epoxy based setting resins, urethane based setting resins, silicone based setting resins and silicon dioxide based setting resins.

10. A detection-membrane according to claim 8, wherein said protective layer is formed from either one, or two or more resins selected from a group consisting of polyimides, fluororesins, polyethylene terephthalate and polystyrene.

11. A detection-membrane according to claim 1, wherein said protective layer is formed from either one of a metal selected from a group consisting of Au, Cr, Ni, Zr and Pt, and an alloy comprising at least one metal selected from said group.

12. A detection-membrane according to claim 1, wherein said protective layer is formed from either one or both compounds from a group consisting of SiO₂ and Si₃N₄.

13. A detection-membrane according to claim 1, wherein a thickness of said detection-membrane is between 0.01 and 20 μm.

14. A detection-membrane according to claim 1, wherein a specific gravity of said detection-membrane is between 14.5 and 0.5.

15. A detection-membrane with a support, wherein a support for supporting a periphery of a detection-membrane according to claim 1 is provided on at least one side of said detection-membrane.

16. A detection-membrane with a support according to claim 15, wherein a surface area of a section of said detection-membrane not supported by said support is between 2×10⁻⁴ and 0.3 cm².

17. A detection-membrane with a support according to claim 15, wherein a protective layer of a synthetic resin is provided on a surface of said detection-membrane facing said support, and said protective layer also functions as an adhesive layer for said support.

18. A detection-membrane with a support according to claim 15, wherein said support is formed from one, or two or more materials selected from a group consisting of Al, Ni, Cu, Fe, Mg, GaAs, Si, GaP, InP, GaAlAs and Al₂O₃.

19. A detection-membrane with a support according to claim 15, wherein said support is formed from one, or two or more materials selected from a group consisting of vinyl based setting resins, epoxy based setting resins, urethane based setting resins and silicone based setting resins.

20. A detection-membrane with a support according to claim 15, wherein said support has a movable section at a joint with said detection-membrane which can move in accordance with vibrations of said detection-membrane.

21. A detection-membrane with a support according to claim 20, wherein said support has a protruding section protruding into a center of said detection-membrane with a length in a direction of said detection-membrane thickness which gradually decreases towards said center, and said protruding section functions as said movable section.

22. A detection-membrane with a support according to claim 20, wherein said movable section is formed from an elastic material.

23. A detection-membrane with a support according to claim 22, wherein said movable section is formed from a single crystal material.

24. A detection-membrane with a support according to claim 23, wherein said single crystal material is any one of materials selected from a group consisting of Si, GaAs, GaAlAs, GaP, InP and Al₂O₃.

25. A detection-membrane with a support according to claim 22, wherein said movable section is formed from a metal.

26. A detection-membrane with a support according to claim 25, wherein said metal is formed from either one of a metal selected from a group consisting of Al, Ni, Cu, Fe and Mg, and an alloy comprising at least one metal selected from said group.

27. A detection-membrane with a support according to claim 22, wherein said movable section is formed from a synthetic resin.

28. A detection-membrane with a support according to claim 27, wherein said synthetic resin is formed from either one, or two or more materials selected from a group consisting of polyimides, fluororesins, epoxy resins, synthetic rubbers, polystyrene, bakelite, polyethylene and polypropylene.

29. An optical sensor comprising a detection-membrane with a support according to claim 15, a light emitting element for irradiating light onto said detection-membrane supported by said support, and a light receiving element for receiving reflected light reflected off said detection-membrane.

30. An optical sensor according to claim 29, wherein said light emitting element and said light receiving element are positioned on a same side of said detection-membrane.

31. A microphone utilizing an optical sensor according to claim 29.

32. A portable communication device utilizing an optical sensor according to claim 29.

33. A method of manufacturing a detection-membrane with a support according to claim 15, comprising a release layer formation step for providing a release layer on a substrate, a lamination step for laminating a detection-membrane on top of said release layer and providing a detection-membrane support on top of said detection-membrane, and a release layer removal step for removing said release layer.

34. A method of manufacturing a detection-membrane with a support according to claim 33, wherein said release layer is formed from a material which is substantially unchanged by said lamination step and can moreover be removed in said release layer removal step without any substantial changes in said detection-membrane and said support.

35. A method of manufacturing a detection-membrane with a support according to claim 33, wherein said release layer is formed from a polyvinyl alcohol resin and is removed in said release layer removal step by dissolution in water.

36. A method of manufacturing a detection-membrane with a support according to claim 33, wherein said support is formed by laminating a support formation layer on top of said detection-membrane and then etching said support formation layer during said lamination step.

37. A method of manufacturing a detection-membrane with a support according to claim 15, comprising a step for laminating a detection-membrane on top of a support formation layer, and a step for etching said support formation layer and forming a support.

38. A detection-membrane with a support in which a support for supporting a periphery of said detection-membrane is provided on at least one side of said detection-membrane, and said support has a movable section at a joint with said detection-membrane which can move in accordance with vibrations of said detection-membrane.

39. A detection-membrane with a support according to claim 38, wherein said support has a protruding section protruding into a center of said detection-membrane with a length in a direction of said detection-membrane thickness which gradually decreases towards said center, and said protruding section functions as said movable section.

40. A detection-membrane with a support according to claim 38, wherein said movable section is formed from an elastic material.

41. A detection-membrane with a support according to claim 40, wherein said movable section is formed from a single crystal material.

42. A detection-membrane with a support according to claim 41, wherein said single crystal material is any one of materials selected from a group consisting of Si, GaAs, GaAlAs, GaP, InP and Al₂O₃.

43. A detection-membrane with a support according to claim 40, wherein said movable section is formed from a metal.

44. A detection-membrane with a support according to claim 43, wherein said metal is formed from either one of a metal selected from a group consisting of Al, Ni, Cu, Fe and Mg, and an alloy comprising at least one metal selected from said group.

45. A detection-membrane with a support according to claim 40, wherein said movable section is formed from a synthetic resin.

46. A detection-membrane with a support according to claim 45, wherein said synthetic resin is formed from either one, or two or more materials selected from a group consisting of polyimides, fluororesins, epoxy resins, synthetic rubbers, polystyrene, bakelite, polyethylene and polypropylene.

47. An optical sensor comprising a detection-membrane with a support according to claim 38, a light emitting element for irradiating light onto said detection-membrane supported by said support, and a light receiving element for receiving reflected light reflected off said detection-membrane.

48. An optical sensor according to claim 47, wherein said light emitting element and said light receiving element are positioned on a same side of said detection-membrane.

49. A portable communication device utilizing an optical sensor according to claim 47.

50. A microphone utilizing an optical sensor according to claim 47.

51. A method of manufacturing a detection-membrane with a support according to claim 38, wherein said support is formed by laminating a support formation layer on top of said detection-membrane and then etching said support formation layer.

52. A method of manufacturing a detection-membrane with a support according to claim 38, wherein said support is formed by laminating said detection-membrane on top of a support formation layer and then etching said support formation layer.
